(19) United States
(12) Patent Application Publication
(10) Pub. No.: US 2019/0182411 A1
(43) Pub. Date: Jun. 13, 2019

(54) WIRELESS REMOTE VIDEO MONITOR

(71) Applicant: SUMMER INFANT (USA), INC., Woonsocket, RI (US)

(72) Inventors: Paul MacPhail Brown, Slatersville, RI (US); Michael Fusco, Greenville, RI (US); Eyal Fishman, Petah-Tikva (IL)

(21) Appl. No.: 16/216,681

(22) Filed: Dec. 11, 2018

Related U.S. Application Data
(60) Provisional application No. 62/597,234, filed on Dec. 11, 2017.

(51) Int. Cl. H04N 5/14; H04N 5/232; G08B 21/02

(52) U.S. Cl. CPC H04N 5/144; G08B 21/0208; H04N 5/23299; H04N 5/23206

(57) ABSTRACT

Methods and apparatus related to a wireless remote video monitor. A method includes providing a camera wirelessly linked to a base station, displaying a graphical user interface (GUI) on the base station, the GUI including an image of a subject captured by the camera, positioning a boundary around the image in the GUI, detecting motion across the boundary, and generating an alarm in response to the detected motion.

### CROSS REFERENCE TO RELATED APPLICATIONS

This application claims benefit from U.S. Provisional Patent Application Ser. No. 62/597,234, filed Dec. 11, 2017, which is incorporated by reference in its entirety.

### STATEMENT REGARDING GOVERNMENT INTEREST

None.

### BACKGROUND OF THE INVENTION

The present invention relates generally to monitoring, and more particularly to a wireless remote video monitor.

In general, parents of infant children often use video systems to monitor young children, such as infants in cribs. These systems typically consist of a camera wirelessly linked to a monitor in which a parent may view a live picture of the infant and in some implementations, listen to audio of the infant. These systems are most often used to monitor the infant while sleeping.

What is needed is a system which alerts a viewer if an infant moves out of a designed area, such as a crib, or when someone approaches the infant and breaches into the designated area.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In an aspect, the invention features system including a camera wirelessly linked to a base station, the base station including at least a graphical user interface (GUI), a user adjustable boundary positioned about a subject displayed in the GUI, means for detecting motion across the boundary, and means for sounding an alarm in response to the detected motion.

In another aspect, the invention features a method including providing a camera wirelessly linked to a base station, displaying a graphical user interface (GUI) on the base station, the GUI including an image of a subject captured by the camera, positioning a boundary around the image in the GUI, detecting motion across the boundary, and generating an alarm in response to the detected motion.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

These and other features, aspects, and advantages of the present invention will become better understood with reference to the following description, appended claims, and accompanying drawings where:

FIG. 1 is a block diagram of an exemplary wireless remote video monitoring system.

FIG. 2 is a block diagram of an exemplary base unit.

FIG. 3 is a block diagram of an exemplary base unit graphical user interface (GUI).

FIG. 4 is a flow diagram.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

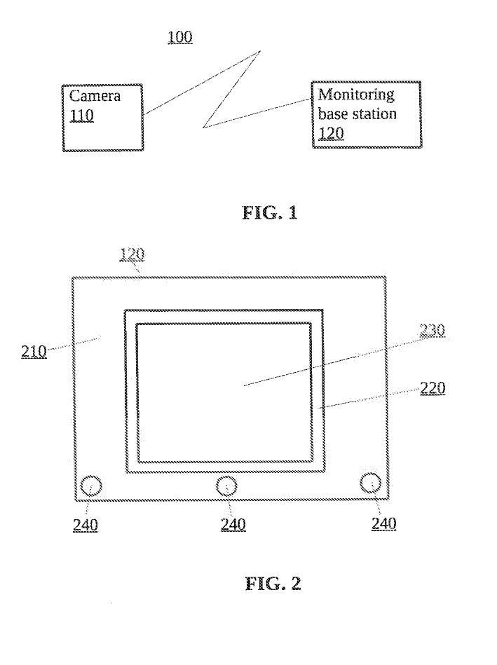

As shown in FIG. 1, an exemplary wireless remote video monitoring system 100 includes a camera 110 and a monitoring base unit 120. The camera 110 is wirelessly linked to the monitoring base station 120. In one implementation, wireless 2.4 GHz FHSS technology is utilized, which offers a reliable connection for better range and less chance of a dropped signal. In one implementation, the camera 110 can include pan, tilt, and zoom features. The camera 110 is typically positioned near an infant, such as an infant sleeping in a crib. The camera 110 captures real-time video and audio in a baby's room. The monitoring base unit 120 is typically remotely positioned so that it is convenient for a user (e.g., parent) to set-up and utilize away from the camera 110.

As shown in FIG. 2, the monitoring base unit 120 includes body 210 and a display 220. The body 210 may contain one of a processor and memory. The display 220, which may be color LCD, presents a graphical user interface (GUI) 230. The body 210 includes a number of control buttons 240 that enable a user to setup and control the monitoring base unit 120 and its wireless connection to the camera 110.

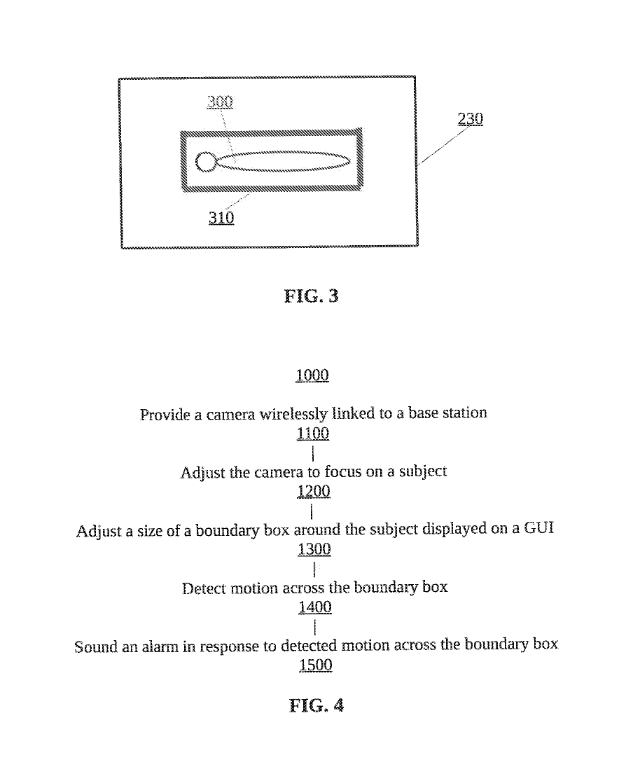

As shown in FIG. 3, the GUI 230 displays live video from the camera 110. In this example, the GUI 230 is used to display an infant 300 in, for example, a bed. In addition, the GUI 230 includes a boundary feature. More specifically, the GUI 230 enables a user to establish a boundary shape 310 around the infant 300. Although the boundary shape 310 as implemented in FIG. 3 as a rectangle, other embodiments implement the boundary shape 310 as geometric shapes, such as a square, a circle, an oval, a triangle, a rhombus, and so forth. The boundary shape 310 is user controllable and thus adjustable so that the entire infant 300 is displayed within the boundary shape.

The monitoring base unit 120 includes a process 1000 that detects any motion crossing over the boundary shape 310. Process 1000 includes video motion detection (VDM) technology that changes in the pixels within the thickness of the boundary shape 310. More specifically, VDM is used to trigger alarms in the monitoring base unit 120 by sensing physical movement in a given area. The VDM uses a simple algorithm which continually analyses current live image data against a reference image from a previous frame. Any significant changes triggers an alert. This alert can be used to initiate many actions such as moving a pan-tilt-zoom camera to a specified point or operating an external device such as turning on a light or sounding an alarm, and so forth.

In the present application, the boundary shape 310 has a profile thickness of several pixels that creates an invisible boundary around the infant 300 that sends a parent an alert if there are any changes or activities that cross over the boundary shape 310. A such, regular movements of the infant 300 are not detected, only those movements of the infant 300 that cross the boundary shape 310 or movements of objects that cross the boundary shape 310 toward the infant 300.

As shown in FIG. 4, process 1000 includes providing a camera (1100) wirelessly linked to a base station. Process 1000 includes adjusting (1200) the camera to focus on a subject.

Process 1000 includes adjusting (1300) a size of a boundary box around the subject displayed on a graphical user interface (GUI).

Process 1000 includes detecting (1400) motion across the boundary box.

Process 1000 includes sounding (1500) an alarm in response to detecting (1400) the motion across the boundary box.

Various embodiments may be implemented using hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system comprising:
a camera wirelessly linked to a base station, the base station including at least a graphical user interface (GUI);
a user adjustable boundary positioned about a subject displayed in the GUI;
means for detecting motion across the boundary; and
means for sounding an alarm in response to the detected motion.

2. The system of claim 1 boundary is a box.

3. The system of claim 2 wherein a shape of the box is selected for the group consisting of a square, a rectangle, a triangle, a circle, an oval and a rhombus.

4. The system of claim 1 wherein the camera includes one or more of a pan feature, a tilt feature, and zoom features.

5. The system of claim 1 wherein the alarm is user adjustable.

6. The system of claim 1 wherein the alarm is an audio alarm.

7. The system of claim 1 wherein the alarm is a visual alarm.

8. A method comprising:
providing a camera wirelessly linked to a base station;
displaying a graphical user interface (GUI) on the base station, the GUI including an image of a subject captured by the camera;
positioning a boundary around the image in the GUI;
detecting motion across the boundary; and
generating an alarm in response to the detected motion.
